(19) United States
(12) Patent Application Publication
(10) Pub. No.: US 2012/0218886 A1
(43) Pub. Date: Aug. 30, 2012

(54) Method and Apparatus

(76) Inventors: Vinh Van Phan, Oulu (FI); Ling Yu, Oulu (FI); Kari Veikko Horneman, Oulu (FI)

(21) Appl. No.: 13/499,125

(22) PCT Filed: Oct. 30, 2009
(86) PCT No.: PCT/EP2009/064374

§ 371 Date: May 4, 2012

(30) Foreign Application Priority Data
Sep. 29, 2009 (GB) 0917069.7

(51) Int. Cl. H04W 28/08; H04W 72/04; H04W 36/22; H04W 88/04

(52) U.S. Cl. 370/229; 370/315

(57) ABSTRACT

A system includes a base station and a plurality of relay nodes defining a group. Each of said relay nodes has a direct connection with the base station. Each of the relay nodes is connected to at least one other relay node, whereby at least one direct connection of one relay node is configured to at least one of receive and send information for another of said relays nodes.

The present invention relates to a system, apparatus, relay nodes, methods and computer programs.

A communication system can be seen as a facility that enables communication sessions between two or more entities such as mobile communication devices and/or other stations associated with the communication system. A communication system and a compatible communication device typically operate in accordance with a given standard or specification which sets out what the various entities associated with the system are permitted to do and how that should be achieved. For example, the standard or specification may define if a communication device is provided with a circuit switched carrier service or a packet switched carrier service or both. Communication protocols and/or parameters which shall be used for the connection are also typically defined. For example, the manner how the communication device can access the communication system and how communication shall be implemented between communicating devices, the elements of the communication network and/or other communication devices is typically based on predefined communication protocols.

In a wireless communication system at least a part of the communication between at least two stations occurs over a wireless link. Examples of wireless systems include public land mobile networks (PLMN), satellite based communication systems and different wireless local networks, for example wireless local area networks (WLAN). The wireless systems can be divided into cells, and are therefore often referred to as cellular systems.

A user can access the communication system by means of an appropriate communication device. A communication device of a user is often referred to as user equipment (UE). A communication device is provided with an appropriate signal receiving and transmitting arrangement for enabling communications with other parties. Typically a communication device is used for enabling the users thereof to receive and transmit communications such as speech and data. In wireless systems a communication device provides a transceiver station that can communicate with e.g. a base station of an access network servicing at least one cell and/or another communications device. Depending on the context, communication device or user equipment may also be considered as being a part of a communication system. In certain applications, for example in ad-hoc networks, the communication system can be based on use of a plurality of user equipment capable of communicating with each other.

The communication may comprise, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. The user may also be provided broadcast or multicast content. Non-limiting examples of the content include downloads, television and radio programs, videos, advertisements, various alerts and other information.

3^{rd} Generation Partnership Project (3GPP) is standardizing an architecture that is known as the long-term evolution (LTE) of the Universal Mobile Telecommunications System (UMTS) radio-access technology. The aim is to achieve, inter alia, reduced latency, higher user data rates, improved system capacity and coverage, and reduced cost for the operator. A further development of the LTE is referred to herein as LTE-Advanced. The LTE-Advanced aims to provide further enhanced services by means of even higher data rates and lower latency with reduced cost. The various development stages of the 3GPP LTE specifications are referred to as releases.

Since the new spectrum bands for international mobile telecommunications (IMT) contain higher frequency bands and LTE-Advanced is aiming at a higher data rate, coverage of one Node B (base station) may be limited due to the high propagation loss and limited energy per bit. Relaying has been proposed as a possibility to enlarge the coverage. Apart from this goal of coverage extension, introducing relay concepts may also help in the provision of high-bitrate coverage in a high shadowing environment, reducing average radio-transmission power at the User Equipment (UE). This may lead to long battery life, enhanced cell capacity and effective throughput, e.g., increasing cell-edge capacity, balancing cell load, enhancing overall performance, and reducing deployment costs of radio access networks (RAN). The relaying would be provided by entities referred to as Relay stations (RSs) or Relay Nodes (RNs). The relay nodes can be fixed or mobile, for example mounted to a high-speed train. In some systems the relay stations may be opportunistically available user equipment/mobile terminals that are not owned by the network itself.

According to an aspect, there is provided a system comprising: a base station; a plurality of relay nodes defining a group, each of said relay nodes having a direct connection with the base station, each of said relay nodes being connected to at least one other relay node, whereby at least one direct connection of one relay node is configured to at least one of receive and send information for another of said relays nodes.

According to an aspect, there is provided an apparatus comprising; at least one processor and at least one memory including program code, the at least one memory and the program code configured to, with the at least one processor cause the apparatus at least to perform: defining a group of relay nodes, each of said relay nodes of said group of relay nodes having a direct connection with a common base station; and determining information scheduling for said group of relay nodes, wherein information for one relay node of the group is at least one of sent to and received from at least one other relay node of the group, said at least one other relay node having a direct connection with said node.

According to an aspect, there is provided an apparatus comprising: a controller for controlling sending and/or receiving of information directly to and/or from a group of relay nodes by transmitter means and/or receiver means, wherein said controller is configured such that information for one relay node of the group is at least one of sent to and received from at least one other relay node of the group, each node of said group having a direct connection with a common base station.

According to an aspect, there is provided a relay node in a group of nodes comprising:

transmitter means and/or receiver means for sending and/or receiving information directly to and/or from a base station and at least one other relay node of the group of nodes, wherein information associated with another relay node of the group is at least one of sent to and received from said another relay node, said another relay node having a direct connection with said base station.

According to an aspect, there is provided a method comprising: determining if a relay node is to be part of a group of relay nodes or to be treated as an individual relay node, wherein each relay node of said group of relay nodes is arranged to have a direct connection to a common base station; and for those relay nodes in said group of nodes, at least one of causing sending information to one relay node of said group, said information for another relay of said group and
causing receiving information from one relay node of the group, said information being received by said one relay node from another relay of the group.

According to an aspect, there is provided a method comprising: determining for a group of relay nodes respective loading for each of said relay nodes, each of said relay nodes having a direction connection to a base station; and determining data scheduling for said group of relay nodes in dependence on said determined loading wherein said data scheduling is such that information for one relay node of the group is at least one of sent to and received from at least one other relay node of the group, said at least one other relay node having a direct connection with said node.

According to an aspect, there is provided an apparatus comprising: means for defining a group of relay nodes, each of said relay nodes of said group of relay nodes having a direct connection with a common base station; and means for determining information scheduling for said group of relay nodes, wherein information for one relay node of the group is at least one of sent to and received from at least one other relay node of the group, said at least one other relay node having a direct connection with said node.

According to an aspect, there is provided an apparatus comprising: at least one processor and at least one memory including program code, the at least one memory and the program code configured to, with the at least one processor cause the apparatus at least to control sending and/or receiving of information directly to and/or from a group of relay nodes by a transmitter and/or receiver, such that information for one relay node of the group is at least one of sent to and received from at least one other relay node of the group, each node of said group having a direct connection with a common base station.

According to an aspect, there is provided a relay node in a group of nodes comprising:

A transmitter and/or receiver configured to send and/or receive information directly to and/or from a base station and at least one other relay node of the group of nodes, wherein information associated with another relay node of the group is at least one of sent to and received from said another relay node, said another relay node having a direct connection with said base station.

According to an aspect, there is provided an apparatus comprising: at least one processor and at least one memory including program code, the at least one memory and the program code configured to, with the at least one processor cause the apparatus at least to perform determining if a relay node is to be part of a group of relay nodes or to be treated as an individual relay node, wherein each relay node of said group of relay nodes is arranged to have a direct connection to a common base station; and for those relay nodes in said group of nodes, at least one of causing sending information to one relay node of said group, said information for another relay of said group and causing at least one processor and at least one memory including program code, the at least one memory and the program code configured to, with the at least one processor cause the apparatus at least to perform receiving information from one relay node of the group, said information being received by said one relay node from another relay of the group.

For a better understanding of some embodiments of the invention, reference will be made by way of example only to the accompanying drawings in which:

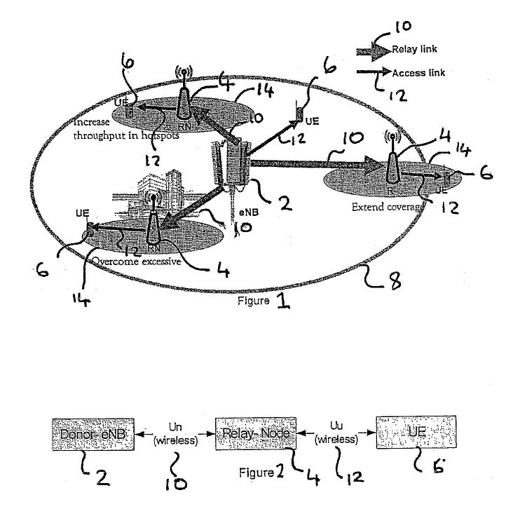

FIG. 1 shows a cell with three relay nodes;

FIG. 2 shows the interfaces between a relay node, a base station and a UE (user equipment):

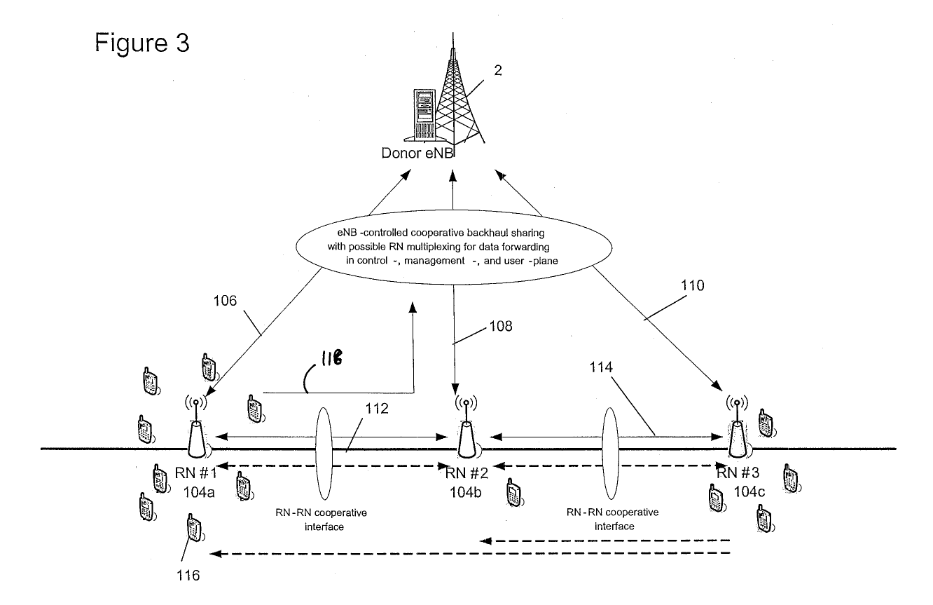

FIG. 3 shows a first embodiment of the invention, with cooperation between three relay nodes associated with one base station;

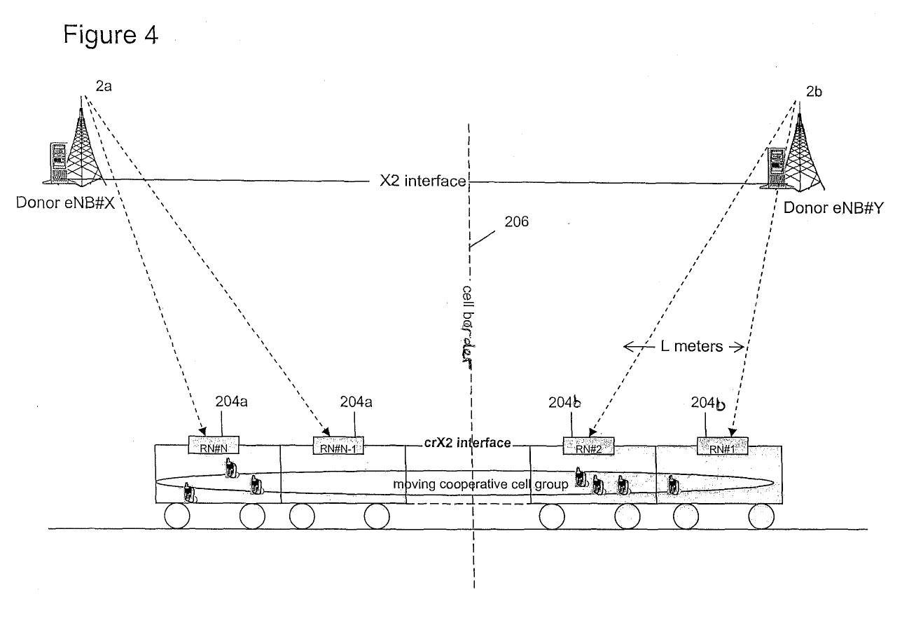

FIG. 4 shows a second embodiment of the present invention with cooperation between relay nodes associated with different base stations;

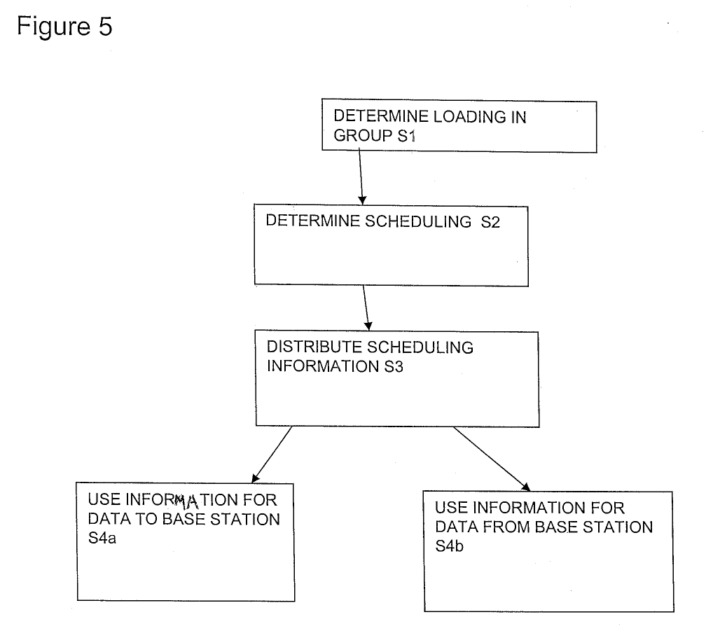

FIG. 5 shows a flow chart of a method embodying the present invention;

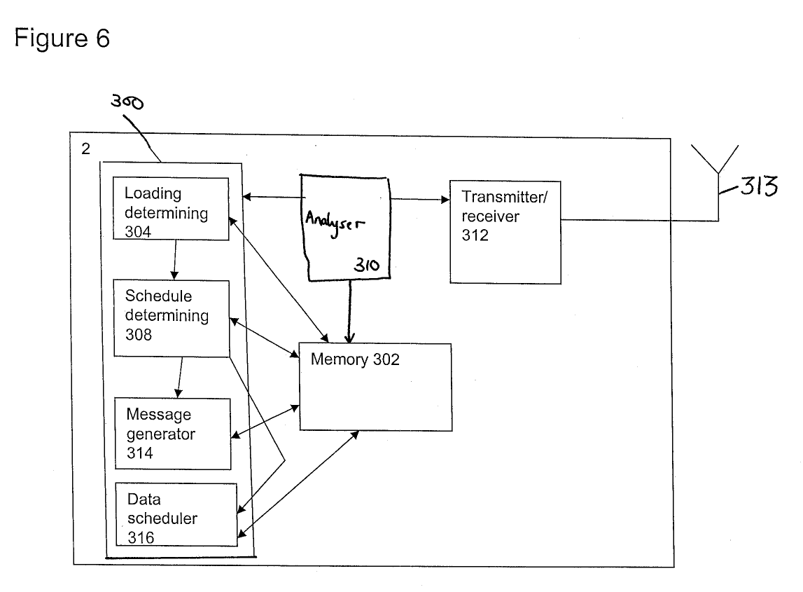

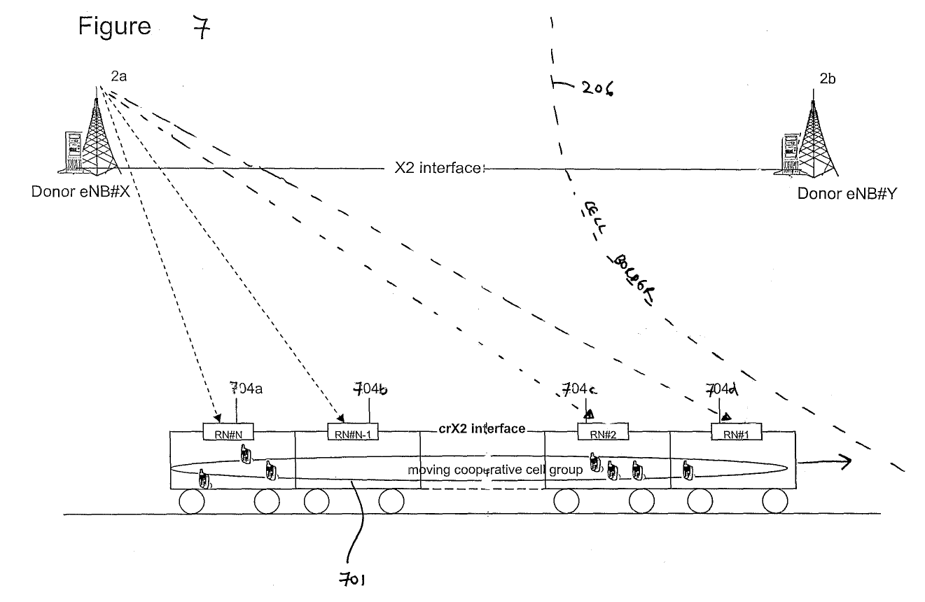

FIG. 6 shows schematically a block diagram of a node embodying the present invention;

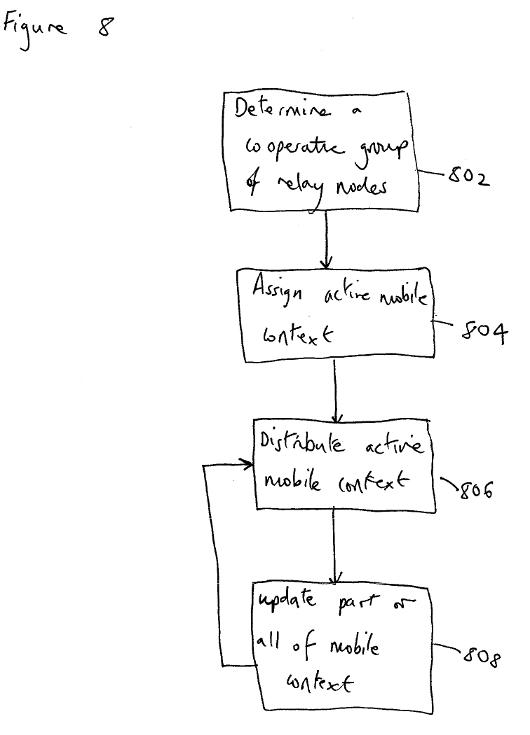

FIG. 7 shows a third embodiment with cooperation between relay nodes moving between different base stations;

FIG. 8 shows a flow chart of a method embodying the present invention.

As specified in 3GPP TR 36.814 (Third Generation Partnership Project) relaying is considered as one of the potential techniques for LTE-A where a RN is wirelessly connected to the radio-access network via a donor cell. Some embodiments of the invention are described especially in the context of the LTE-A proposals. However, some embodiments of the invention can be used in any other scenario which for example requires or uses one or more relays.

Reference is made to FIG. 1 which shows part of a LTE radio access network (RAN). An access node 2 is provided.

The access node can be a base station of a cellular system, a base station of a wireless local area network (WLAN) and/or WiMax (Worldwide Interoperability for Microwave Access). In certain systems the base station is referred to as Node B, or enhanced Node B (e-NB). For example in LTE-A, the base station is referred to as e-NB. The term base station will be used in the following and is intended to include the use of any of these access nodes or any other suitable access node. The base station 2 has a cell 8 associated therewith. In the cell, there is provided three relay nodes 4. This is by way of example only. In practice there may be more or less than three relay nodes. One of the relay nodes 4 is provided close to the edge of the cell to extend coverage. One of the relay nodes 4 is provided in a traffic hotspot and one of the relay nodes is provided at a location where there is an issue of shadowing from for example buildings.

Each of the relay nodes has a coverage area 14 associated therewith. The coverage area may be smaller than the cell 8, of a similar size to the cell or larger than the cell. A relay link 10 is provided between each relay node 4 and the base station 2. The cell has user equipment 6. The user equipment is able to communicate directly with the base station 2 or with the base station 2 via a respective relay node 4 depending on the location of the user equipment 6. In particular, if the user equipment 6 is in the coverage area associated with a relay node, the user equipment may communicate with the relay. The connections between the user equipment and the relay node and the direct connections between the user equipment and the base station are referenced 12.

The UE or any other suitable communication device can be used for accessing various services and/or applications provided via a communication system. In wireless or mobile communication systems the access is provided via an access interface between mobile communication devices (UE) 6 and an appropriate wireless access system. The UE 6 can typically access wirelessly a communication system via at least one base station. The communication devices can access the communication system based on various access techniques, such as code division multiple access (CDMA), or wideband CDMA (WCDMA), the latter technique being used by some communication systems based on the third Generation Partnership Project (3GPP) specifications. For LTE, OFDMA (Orthogonal Frequency Division Multiplexing) in the DL (down link) and single-carrier FDMA in the UL (uplink) is used. Other examples include time division multiple access (TDMA), frequency division multiple access (FDMA), space division multiple access (SDMA) and so on. In a wireless system a network entity such as a base station provides an access node for communication devices.

Each UE may have one or more radio channels open at the same time and may receive signals from more than one base station and/or other communication device.

In some, but not all, embodiments of the invention, there may be an issue of backwards compatibility for earlier versions of the standard. For example in one embodiment, from UE's viewpoint, the serving network node should serve Release 8 (of the 3GPP standard) user equipment. Due to this requirement the relays may support at least some and in some embodiments all of the main eNB functions.

A “type 1” RN has been proposed, which is an inband relaying node having a separate physical cell ID (identity), support of HARQ (Hybrid automatic repeat request) feedback and backward compatibility to Release 8 (Rel 8) UEs. It should be appreciated that other types of Relay node are being considered which have different functionality associated therewith.

In the RAN2 #65bis meeting (part of 3GPP), RAN 2 agreed with the definition for the nodes and the interfaces as shown in FIG. 2. The wireless interface 12 between UE 6 and RN is named the Uu interface. For those embodiments where backward compatibility is desirable for example where compliance with a particular version of 3GPP standards TR 36.913 and TR36.321 is provided, the Uu interface maybe consistent with the Release 8 interface as defined in LTE. The wireless interface 10 between the RN 4 and the donor e-NB 2 is the Un interface. The link is considered as backhaul link.

In one embodiment of the invention, a smart cooperative relay system, targeted for 3GPP LTE-A and ITU IMT-A cellular networks is provided. A close cooperative group of relay nodes (RN) is arranged to be connected and relayed to the same (or different neighbouring) donor eNB(s), to be interconnected and share the wireless backhaul (that is, the link between RN and donor eNB) capacity in an efficient, coordinated and controlled manner.

Such an arrangement may be used where a plurality of RNs is provided to enhance cellular coverage in and in-door building, a cell-edge local area, or on board passenger trains, cruise ships, etc.

Relays which are moving and/or which cooperate are provided in some embodiments of the invention.

Some embodiments of the invention may permit devices to be used as elements of mesh networks. Flexible spectrum use between different RAT (radio access technology) may be possible.

Embodiments of the invention may be used for mobile backhaul and transport situations such as railway solutions thereof. Mobile backhaul is the use of a communications system with at least one radio connection between two network nodes other than the user equipment along a data path. Mobile backhaul may get data from an end user to a node in a network such as the Internet or the like.

In some embodiments of the invention, different diversities are utilized. By way of example only, one or more of space, time and user diversities, associated with a close cooperative group of RNs may be utilized in order to improve radio resource utilization on the wireless backhaul for improved or more optimized network operation and performance.

Various interactions among cooperative RNs and between RNs and donor eNB(s), for control signalling and/or for data transfer will now be described.

Embodiments of the present invention define a cooperative group or cluster of relay nodes for capacity sharing on the wireless link between a relay node and a donor eNB. This is in order to facilitate load balancing systems.

It should be noted that this contrasts with a multi hop relay system in which only the last hop is directly connected to a base station. In contrast, in one preferred embodiment of the present invention, each relay node in the cooperative cluster is directly connected to one base station. In an alternative embodiment of the present invention, a cooperative cluster or group of relay nodes may be connected to more than one base station.

It should be appreciated that in some embodiments of the present invention, there may be a multi hop relay where one relay of the cluster is connected to a further relay. If that relay is not itself connected to the base station, that latter relay may not be considered part of the cluster or group.

The relay nodes in a group or cluster are connected to each other using wired or wireless interfaces. It is not necessary that each relay node be connected directly to each other relay node. In some embodiments of the present invention, the relay nodes in a cluster are connected directly or indirectly to each other relay node in the group. It should be appreciated that in some embodiments of the present invention, each relay node may be connected to another relay node.

In one alternative, the cluster or group of relay nodes may be divided into two or more subgroups. In that case, a single connection may be provided between the subgroups.

It should be appreciated that some embodiments of the invention can be used in an arrangement where a particular relay node is always associated with a given base station. The group to which the particular relay node belongs may be constant or may be altered.

Alternatively in some embodiments of the invention, the base station with which a relay node is associated can change over time. The group to which the particular relay node belongs may be constant or may be altered.

One situation where the base station with which a relay node is associated may change over time is where relay nodes are provided on a train and the base stations are stationary. Consider the following example: a passenger train having a length of e.g. 300 meters and a travelling speed varying from 10 m/s to 100 m/s, may need from 3 seconds to 30 seconds to pass through a cell border. There may be a large number of users on board, even a thousand or more. 1^{st}-class cabins or coaches may have less users, whereas 2^{nd}-class cabins or coaches may have a much higher user density. In some embodiments there may therefore be significant amounts of time and space provided to explore time-space diversities associated with such a moving relay system, together with user diversities resulting from service traffic demands and spatial distribution of mobile users on board. The code and frequency diversities are of course there to utilize as well.

As previously mentioned, in some embodiments of the invention, the relay may be Rel'8 backward compatible, with in-band relay extensions for LTE E-UTRAN. One issue for some embodiments is how to schedule and allocate resources for a RN to switch between communicating with a donor eNB and communicating with UE in time with minimum impact on regular Rel'8 operation, L1 HARQ in particular.

A semi-static sub-frame configuration of the frame structure may be used based upon predefined allocation patterns, e.g., over 4 ms or 4 sub-frames period of HARQ synchronized delay between transmission and reception. This results in a semi-static split of about 25%-75% (transmission-reception), 50%-500 or 75%-25% between the RN-UE and RN-eNB allocations for individual RN in time. Thus, there may be a notable “imbalance” in the cases of 25%-75% and 75%-25% regarding the operation of the particular RN under consideration. The 25%-75% case may imply a possible under-utilization of available wireless backhaul resources. The 75-25% case meanwhile may point to a possible lack of available wireless backhaul resources to serve a relatively highly loaded RN cell.

Thus in one embodiment of the invention, it may be desirable to have a cooperative sharing of available wireless backhaul resources between e.g. a first RN of 25%-75% and a second RN of 75%-25% for enhanced duplexing operation and load-balancing.

In some embodiments of the invention, there is provided a plurality of relay nodes forming a group. The RNs of a close cooperative group may be characterized by, e.g., spatial and operational togetherness in deployment and used to provide efficient cellular coverage extension to a particular common service area. Examples of such common service areas are inside buildings, passenger trains, cruise ships or the like.

The relays may be inter-connected with a RN-RN cooperative interface. This interface may be realized using either a wire-line interface (e.g., such as the X2 interface or a similar interface) or a radio interface operating on a different spectrum band than that of the donor cellular system (out of band). The RN-RN connection thus does not interfere with the duplexing radio operation of the donor cellular system including RNs. This may result in advantages, and may avoid problems from regular in-band multi-hop relays.

RNs in the cooperative group may be configured to indicate, report, and/or negotiate with donor eNB about their RN-RN cooperative interface related status, capacity and/or capability information. This may be done upon initial activation and reactivation, cell change, on a periodical basis, in response to a request or at any suitable time.

The donor eNB or the network side via the donor eNB may have at least some control over the configuration and operation of RNs and their cells. The donor eNB and/or network may control RN-RN connections between RNs in the cooperative group for cooperative cellular data forwarding and control signaling. In case the RN-RN interface is a radio interface, the donor eNB is responsible for resource partitioning and channel allocation of the RN-RN connections within the close cooperative group.

The functions and services of the proposed RN-RN interface may comprise one or more of the following:

UL (uplink) and DL (downlink) data forwarding over the backhaul link for any of RNs in the group: one RN may forward data for another RN and possible data multiplexing/de-multiplexing of different RNs may be applied at the donor eNB and/or forwarding RN.

There may be the distribution or exchange of relevant system information, status information, and/or control signalling related to the wireless backhaul link (such as one or more of: on-the-run notifications of cell change; system information update; paging; load status; synchronization status; timing advance information; etc.)

The donor eNB or the network side may address a close cooperative group of RNs with a unique group radio network temporary identity (RNTI) common to all RN members. Thus, individual RN member may be configured with an individual RNTI and a group RNTI. The group RNTI is used for common control and data forwarding purposes by the donor eNB and/or the RN.

The donor eNB or network side may select, coordinate and/or control RNs in the close cooperative group for a duplexing operation, load-balancing and/or backhaul-link capacity sharing:

Reference is made to FIG. 3 which shows a base station 2 and associated group of relay nodes 104a, 104b and 104c. As can be seen from FIG. 3, the base station is connected to the first relay node 104 via a wireless connection 106. The second relay node 104b is connected to the base station via wireless connection 108. Finally the third relay node 104c is connected to the base station 2 via a wireless connection 110.

In the group shown in FIG. 3, the first relay node 104a is connected to the second relay node 104b. The second relay node 104b is connected to the third relay node 104c. Thus, communication between the first relay node 104a and the third relay node 104c is via the second relay node 104b. Alternatively, the first relay node 104a may additionally be connected directly to the third relay node 104c. The connection between the first relay node 104a and the second relay node 104b is via connection 112. This connection may be a wireless connection or alternatively may be a wired connection. A wireless connection 114 is provided between the second relay node 104b and the third relay node 104c. In alternative embodiments of the present invention, it is possible that this connection is a wired connection.

As can be seen from FIG. 3, each relay node has associated with it one or more user equipment 116. In the example shown in FIG. 3, the first relay node 104a is arranged to communicate with a relatively large number of user equipment as compared to, for example, the second relay node 104b or the third relay node 104c. Accordingly, most of the available radio resource for the first relay node 104a will be allocated to the connections between the relay node and the user equipment. Accordingly, some of the communication which needs to take place between the first relay node 104a and the base station 2 will be via the second relay node 104b as indicated schematically by path 118. It should be appreciated that in one embodiment of the present invention, the uplink and downlink traffic in the link between the first base station and the first relay node may be divided. Accordingly, only communications from the first relay node to the base station will use the connection 106 which is directly between the first relay node 104a and the base station 2. The data from the base station to the first relay node 104a may take the path marked 118, via the second relay node 104b.

It should be appreciated that this is by way of illustration only and of course the information from the first relay node may go via the second relay node to the base station and the information from the base station 2 may go directly to the first relay node 104a. In alternative embodiments of the present invention, one or more of the paths may have both uplink and downlink traffic. In more complicated arrangements, it is possible that additionally the path between the first relay node to the second relay node to the third relay node to the base station may be used for at least some traffic. This may be advantageous, particularly in the case where the second relay node is connected to a relatively large number of user equipment and alternative routing via one or other or both the first and third relay nodes may be used for data or information to or from the second relay nodes.

In the example shown in FIG. 3, the third relay node is used for notifying the first and second relay nodes about expected upcoming events. This information may come from the base station.

The base station is thus arranged to provide cooperative backhaul sharing, and optionally relay node multiplexing for data forwarding in control, management and user planes.

Reference is made to FIG. 4 which shows a second embodiment of the present invention. In this arrangement, there is a first base station 2a and a second base station 2b. Associated with the first base station are a group of relay nodes. These relay nodes are referenced 204a. The second base station 2b has a second group of relay nodes associated therewith. These relay nodes are referenced 204b.

The first base station 2a is connected to the second base station 2b via the X2 interface. This interface may be a wired or wireless connection.

The first base station 2a is connected to each of its relay nodes 204a. These relay nodes 204a are arranged to be connected to each other. Thus, the relay nodes associated with the first base station 2a are each arranged to be directly connected to that base station and are also arranged to be connected to one another directly or indirectly. A similar scenario exists in relation to the second base station 2b which is directly connected to each of its relay nodes 204b. Again, the relay nodes associated with the second base stations 2b are arranged to be connected to each other, either directly or indirectly. As can be seen, there is a cell border represented by dotted line 206. This represents the border between the cell associated with the first base station 2a and the cell associated with the second base station 2b. The user equipment is arranged to be associated with respective ones of the relay nodes. It should be appreciated that at least one relay node associated with the first base station is connected to at least one relay node associated with the second base station 2b. Accordingly, in this example, the group of relay nodes can be considered to comprise those relay nodes associated with the first base station and those relay nodes associated with the second base station.

It should be appreciated that the embodiment shown in FIG. 4 is shown in the context of a moving train. As can be seen, different ones of the relay nodes have different numbers of user equipment and accordingly will have different loading in the connection between the user equipment and the respective relay node. Sharing on the backhaul link can then be used in a similar manner as described in relation to FIG. 3. It is therefore possible that information which is to go from a relay node of the first group may follow a path to a relay node 204b of the second group, the second base station 2b and the first base station 2a or vice versa.

In arrangements shown in FIG. 4, the relay nodes may be considered to be subgroups. Accordingly, the first subgroup is associated with the first base station and the second subgroup is associated with the second base station. In this arrangement, sharing of a backhaul wireless link between the relay nodes of different groups may occur if all of the backhaul links associated with the subgroup of which the relay node in question belongs are relatively overloaded. In other embodiments sharing of the backhaul wireless link occurs after completing an on-going transmission before switching to a new base station. Alternatively in other embodiments the backhaul wireless link may be shared for enhancing the reliability and effectiveness of the control signalling and data transmission.

This relay group may be considered as a new logical network entity (cooperative cell cluster) which may be defined, designated and supported by the donor cellular system. The network may be able to configure (initially as well as reconfigure) and then operate such group in an effective way. Because the relay nodes may be reactivated/deactivated on the run, the issue such as how the group can be formed, configured and reconfigured may need to be considered in some embodiments. For example, it is possible that when the first RN is activated and does not find any other RN connected to it, this RN can be handled as a single RN. Then, when a second RN is activated that already has or can have an active connection to the first RN, the base station may decide to reconfigure the first RN and the second RN as a cooperative group, taking into account the connection and possible cooperation capability between the RNs. The second RN may indicate about possible connection and cooperation with the first RN to the base station or request the first RN to indicate that to the base station for example, upon reactivation. This process is carried out upon reactivation of 3rd, 4^{th} . . . RNs into the group and/or deactivation of existing RN from the group. This is by way of example only. Alternatively, the configuring of a group may be done in dependence on the result of a poll by the base station. This poll may be performed at regular intervals and/or in response to one or more changes.

These changes may be the activation, deactivation or reactivation of one or more relay nodes or a change in traffic in the cell or cells associated with the base station and/or relay nodes.

Reference will now be made to FIG. 5 which shows a method embodying the present invention. In step S1, loading in the group is determined. In particular, the loading between each relay node and its associated user equipment is determined along with the loading between the respective relay node and the base station. This determining may take place in some embodiments, in the base station. In alternative embodiments of the present invention, it may take place in one of the relay nodes. In yet another embodiment of the present invention, this information may be determined by each relay node and then shared there between, in the distributed approach.

In one modification to this, there is an additional step, which may take place prior to step S1, after S1 or be part of step S1 where the group of relay nodes is determined. In other words it is determined if the one or more relay nodes are to act as individual nodes with no sharing of resource on the backhaul link or if two or more relay nodes will define a group. In the latter case, a determination will take place as to which relay nodes will define the group. This step may take place in a base station.

In step S2, based on this determined loading in the groups of relay nodes, the scheduling is determined. In one embodiment of the present, this scheduling may be determined in the base station. In alternative embodiments of the present invention, this information may be determined by one of the relay nodes or in an alternative embodiment, may be determined in cooperation between two or more relay nodes.

In step S3, the scheduling information is distributed to each of the relay nodes. In one embodiment of the present invention, the base station will forward that information directly to each of the relay nodes. In an alternative embodiment of the present invention, the base station sends the information to one or more, but not all of the relay nodes. The one or more relay nodes which receive the information then distribute the scheduling information to the other relay nodes.

It should be appreciated that if the schedule information is determined by one or more of the relay nodes, then that information needs to be distributed to the base station.

In step S4a, the scheduling information is used via the base station for controlling the transmission of data to the one or more relay nodes. In particular, the base station will use the information to determine which one or more of the relay nodes the information is to be sent for a particular relay node. For example, the base station may send data intended for a particular relay node to that relay node along with information intended for a different relay node. It should be appreciated that this information may be used in order to multiplex together data for different relay nodes which are to be transmitted to the same relay node. This scheduling information is also used in step S4b for controlling which relay node sends information to the base station. Also to control the communication of data between relay nodes. Thus, a relay may multiplex data from that relay station and one or more other relay stations and send that to the base station. It should be appreciated that steps S4a and S4b can take place at more or less the same time, or differing times.

It should be appreciated that in the above, one or more steps have been described as being carried out by a base station. In some embodiments, one or more of these steps may alternatively or additionally be carried out in a network element.

The frequency with which one or more of the above described steps take place may depend on whether the plurality of relay nodes are moving or are stationary.

In one embodiment a centralized approach is adopted:

The Donor eNB decides and schedules backhaul-link data forwarding between selected RNs, for example from a 75%-25% time-sharing configured RN to a 25%-75% time-sharing configured RN, by communicating with each selected RN directly. It may be assumed that the time sharing between RN-UE and RN-eNB links has a semi-static relay frame structure. A RN that needs more time allocation to serve UEs due to high cell load has less time allocation remaining for the backhaul link which may need to be compensated for by using e.g. more resources in other domains such as frequency or load-balancing cooperation.

In one embodiment, a donor eNB may tell one RN to send (or to receive) one or more of the following:
what types of RB (radio bearer) traffic;
how much traffic in bytes, number of packets or the like;
over what period in sub-frames, or milliseconds or the like:
with which RN over the established RN-RN connection on the basis of resource allocation.

This may be realized via L1 PDCCH (layer 1 Physical Downlink Control Channel) signalling or MAC C-PDU (medium access control coded packet data unit) or RRC (radio resource control) message between donor eNB and RNs.

The backhaul-link data of different RNs may be multiplexed and transmitted between the donor eNB and forwarding RN using individual RN IDs. This data multiplexing may be realized on different levels of wireless backhaul-link protocol stacks, typically L1 PHY (layer 1 physical layer) or L2 MAC (layer 2 medium access control).

The RN that forwards backhaul-link data for another RN may send collective acknowledgement on the success or otherwise of data forwarding to the source, that is, another RN for UL data forwarding or donor eNB for DL data forwarding. In addition or as an alternative to this, an individual RN and donor eNB may exchange status report on backhaul-link data received directly, regardless of whether RN-RN forwarding is involved or not.

In a decentralized approach: a donor eNB decides and schedules backhaul-link data forwarding between selected RNs, for example from a 75%-25% time-sharing configured RN to a 25°-75% time-sharing configured RN, by communicating with one of selected RNs, referred to as a nominated one. This nominated one can be any one of selected RNs, depending on flexibility of protocols used. For an example, this nominated one may be the one that is requested to act as the forwarding RN for other RNs.

The donor eNB may configure and control the nominated RN with necessary flow-control information including scheduling constraints and resource allocations for backhaul-link data forwarding between selected RNs. Then, the nominated RN may redistribute configuration and control information to other RNs as well as coordinate actual data forwarding between RNs.

### Distributed Approach:

The donor eNB may configure and update policies, constraints and states related to possible backhaul-link data forwarding between RNs in the close cooperative group to individual RNs. The on-the-fly cooperation between RNs including control signalling and data forwarding is due to involved RNs.

In aforementioned decentralized and distributed approaches, RNs may be configured and updated about the allocated time-sharing sub-frame configurations of each other, by donor eNB or by RNs.

The throughput of the wireless links may depend on the channel conditions and may vary which allows for potential capacity-sharing and load-balancing opportunities. In some embodiments, it may be assumed that the throughput of the wireless backhaul is stable and wired link is stable, possibly more than the wireless backhaul, so the capacity-sharing and load-balancing opportunities may come from the variation of the ordered traffic. The amount of traffic generated in traffic sources may vary causing a particular link to overload. In some embodiments an overload may be overcome with ordered traffic, such as redirecting excess traffic to another link.

In some embodiments one part of the RN-RN link is also used for the normal cooperative functions such as cooperative MIMO, network coding, etc.

Reference is made to FIG. 6 which shows a block diagram of a node embodying the present invention. This node may be the base station or the relay node. In particular, the data processing part 300 of the node is shown. This data processing part is connected to a transmitter/receiver part 312 which up converts data to be sent on a radio frequency and which down converts data which is received to the baseband. A transmitter/receiver part 312 is connected to an antenna arrangement 313 which is arranged to transmit and receive the signals. The node also comprises a memory 302 which is connected to the data processing part and which is used by various processing functions of the data processing part 300. The data processing part is schematically shown to comprise the following functional blocks: a loading block 304 which is arranged to determine loading in the links between the respective relay nodes and the base station and the respective relay nodes and the user equipment they serve. This determination of loading may be made on the basis of information which has been received via the transmitter/receiver 312 from one or more of the relay nodes. In one embodiment of the present invention, the information which is received by the transceiver/receiver part is analysed by an analyser 310. The analyser may pass the information to the loading determiner 304 and/or pass the information to the memory. Accordingly, the loading determining block 304 may get the required information either from the analyser 310 and/or from the memory. Once the loading has been determined by the loading determiner 304, that information is output to one or more of the memory and the scheduler 308.

The scheduler 308 uses the information in order to determine the scheduling. The determined scheduling information is sent to one or more of the memory 302 and a message generator 314. The message generator 314 generates a message which is transmitted by the transmitter/receiver 312 to the respective one or more relay nodes which comprises the scheduling information. Data scheduler 316 uses the determined loading in order to control the scheduling of the information and may, for example, multiplex together data for one or more relay nodes.

The processing part 300 may be implemented by one or more integrated circuits. The memory may be part of one or more of the integrated circuits or may be separately provided.

FIG. 7 illustrates some alternative embodiments having a cooperative group of relay nodes in coverage of one or more base stations. The arrangement as shown in FIG. 1 is similar to that shown in FIG. 4. The relay nodes 704a, 704b, 704c, and 704d as shown in FIG. 7 is similar to the relay nodes 204a and 204b as shown in FIG. 4.

The relay nodes 704a, 704b, 704c, 704d are moving together as a cooperative group 701 of relay nodes. The relay nodes 704a, 704b, 704c, 704d are part of the infrastructure of a moving structure or vehicle such as a train or a cruise ship. The relay nodes 704a, 704b, 704c, 704d are directly connected to a first or second base station 2a, 2b. The relay nodes are configured to be directly or indirectly connected to one another. This is similar to the embodiments shown in FIG. 4.

FIG. 8 illustrates a flow diagram of information relating to a cooperative group 701 of relay nodes being assigned and distributed through the donor cellular system and the cooperative group of relay nodes.

In some embodiments the cooperative group 701 of relay nodes is be considered as a new logical network entity. The cooperative group 701 of relay nodes may be defined, designated and supported by the donor cellular system. In some embodiments the donor cellular system comprises a controlling means which defines, designates and supports the cooperative group of relay nodes. The controlling means is able to configure and/or reconfigure one or more of the relay nodes of the cooperative group 701 for effective operation within the cellular network. Block 802 shows the donor cellular system determining that cooperative group of network nodes is present. Polling and discovery by the controlling means of the donor cellular system that relay nodes are part of a cooperative group is described in previous embodiments.

On discovery of one or more relay nodes of a cooperative group 701 of relay nodes, group information is assigned to the cooperative group 701 as shown in block 804. In some embodiments the group information comprises an active mobile context. In some embodiments creation of the active mobile context is initiated by a network entity of the donor cellular system. Additionally or alternatively, the creation of the active mobile context is initiated by a relay node of the cooperative group 701. The active mobile context comprises information of the cooperative group 701 of relay nodes. In some embodiments the active mobile context comprises information which varies over time. In other embodiments the active mobile context comprises information which is static. In yet other embodiments the active mobile context comprises both variable and static information.

The active mobile context may comprise one or more of the following information; on-the-run profile of the cooperative group of relay nodes; parameters of specific system configurations and operations; identity of the relay nodes of the cooperative group; capability of one or more relay nodes of the cooperative group; status information of one or more relay nodes of the cooperative group; cooperative roles and operations of one or more relay nodes with respect to other relay nodes of the cooperative group; backhaul links of one or more relay nodes of the cooperative group; and cells of one or more relay nodes of the cooperative group.

The active mobile context may comprise a unique identity for a particular active cooperative group of relay nodes. In this way multiple active cooperative groups are distinguishable from each other by the donor cellular system.

After the cooperative group 701 of relay nodes has been assigned the active mobile context, the active mobile context is distributed to each relay node as shown in block 806. The distribution may be similar to that as discussed for step S3 in FIG. 5. The active mobile context may be exchanged between the relay nodes over an interface such as an X2-like interface, also referred to crX2. In some embodiments the crX2 interface between the relay nodes is a modification of an X2 interface, that is, based upon X2 interface between two neighbouring base stations as specified in LTE E-UTRAN. Alternatively the active mobile context may be exchanged using another means such as another wired and/or wireless interface. Similarly the active mobile context may be exchanged between base stations over an interface such as an X2 interface.

The active mobile context is stored in one or more of the network elements of the donor cellular system. The active mobile context may be stored at each relay node and at base stations of the donor cellular system. Additionally or alternatively the active mobile context may be stored at other network elements such as a network server, mobility management entity (MME), operation and maintenance (O&M) server or other storage means.

As the cooperative group of relay nodes move between base stations of a donor cellular system or otherwise, so the operations and parameters associated with the cooperative group of relay nodes 701 may change. The active mobile context may be updated dynamically to reflect changes to the cooperative group of relay nodes 701 as shown in block 808. The active mobile context may be updated on-the-run, that is as the cooperative group of relays 701 moves, so the active mobile context information is updated dynamically.

A part or all of the active mobile context may be updated. After a part or all of the active mobile context has been updated, the updated active mobile context is distributed as shown in block 806. An update of the active mobile context may be initiated by a relay node of the cooperative group or initiated by a network entity such as a base station, MME or other suitable network entity.

Additionally or alternatively, the active mobile context comprises information relating to handover of one or more of the relay nodes from one base station to another base station. In some embodiments, the active mobile context comprises handover timers which initiate handover of a relay node from the first base station to the second base station. For example the handover timer may take into account the time duration one or more relay nodes of a cooperative group spend in a coverage area of a base station. In some embodiments a handover time may be determined from the travelling speed and physical dimensions of the cooperative group (trains, ships, etc.) and the area of the coverage of a base station. The timing of the handover may be determined by the relay node or the base station.

In some embodiments, the active mobile context may comprise information relating to other conditions for triggering handover. For example in some embodiments load balancing or meeting the criteria of a rule may trigger handover. In other embodiments, a handover may be applied and executed for a first relay node or some relay nodes in a group of relay nodes and some or all of the other relay nodes will be handed over automatically. Automatic handover of the other relay nodes may occur after some predefined timer has expired or an indication message is sent from a source base station to a target base station. The other relay nodes may communication with the target base station via the previously handed over relay node(s).

A non-limiting example of mobile architectures where the herein described principles may be applied is known as the Evolved Universal Terrestrial Radio Access Network (E-UTRAN). The eNBs may provide E-UTRAN features such as user plane Radio Link Control/Medium Access Control/Physical layer protocol (RLC/MAC/PHY) and control plane Radio Resource Control (RRC) protocol terminations towards the user devices.

At least some of the processing of processing block may be carried out by one or more processors in conjunction with one or more memories.

Processing block may be provided by an integrated circuit or a chip set.

At least some of the processing block may alternatively or additionally be provided by a controller of the access points, for example a radio network controller or the like. For example, the determining of the loading and the scheduling may be carried out by such a controller.

The required data processing apparatus and functions of a relay node and a base station apparatus as well as an appropriate communication device may be provided by means of one or more data processors. The above described functions may be provided by separate processors or by an integrated processor. The data processing may be distributed across several data processing modules. A data processor may be provided by means of, for example, at least one chip. Appropriate memory capacity can also be provided in the relevant nodes. An appropriately adapted computer program code product or products may be used for implementing the embodiments, when loaded on an appropriate data processing apparatus, for example in a processor apparatus associated with the base station, processing apparatus associated with relay node and/or a data processing apparatus associated with a UE. The program code product for providing the operation may be stored on, provided and embodied by means of an appropriate carrier medium. An appropriate computer program can be embodied on a computer readable record medium. A possibility is to download the program code product via a data network.

It is noted that whilst embodiments have been described in relation to LTE, similar principles can be applied to any other communication system where relaying is employed. Therefore, although certain embodiments were described above by way of example with reference to certain exemplifying architectures for wireless networks, technologies and standards, embodiments may be applied to any other suitable forms of communication systems than those illustrated and described herein.

It is further noted that whilst some embodiments has been described in relation to a relay node moving from one base station to another base station, the relay node does not necessarily have to be moving. For example, a relay node may be handed over from a first base station to a second base station due to other conditions. A relay node may be handed over due to loading conditions of the first base station or the relay node. Additionally or alternatively a relay node may be handed over to a second base station to increase coverage of the second base station. In some other embodiments a relay node may be handed over due to a shadowing in coverage a first base station. In an alternative embodiment no handover occurs and a relay node is in connection with a first base station and another relay node is in connection with a second base station and the relay nodes communicate with each other.

It is also noted herein that while the above describes exemplifying embodiments of the invention, there are several variations and modifications which may be made to the disclosed solution without departing from the scope of the present invention.

1. A system comprising:
a base station;
a plurality of relay nodes defining a group, each of said relay nodes having a direct connection with the base station, each of said relay nodes being connected to at least one other relay node, whereby at least one direct connection of one relay node is configured to at least one of receive and send information for another of said relays nodes.

2. Apparatus comprising:
at least one processor and at least one memory including program code, the at least one memory and the program code configured to, with the at least one processor cause the apparatus at least to perform:
defining a group of relay nodes, each of said relay nodes of said group of relay nodes having a direct connection with a common base station; and
determining information scheduling for said group of relay nodes, wherein information for one relay node of the group is at least one of sent to and received from at least one other relay node of the group, said at least one other relay node having a direct connection with said node.

3. Apparatus as claimed in claim 2, wherein the at least one memory and the program code is configured to, with at least one processor cause the apparatus to determine for the group of relay nodes respective loading for each of said re-lay nodes.

4. Apparatus as claim in claim 2, wherein the at least one memory and the program code configured to, with at least one processor cause the apparatus to reconfigure said group.

5. Apparatus as claimed in claim 4, wherein the at least one memory and the program code configured to, with at least one processor to cause the apparatus to reconfigure said group if at least one of:
a relay node is deactivated; and a relay node is activated.

6. Apparatus as claimed in claim 2, wherein the at least one memory and the program code configured to, with at least one processor cause the apparatus
to define a group of relay nodes, at least one relay nodes being movable, wherein said at least one relay node is added to said group when said relay node is determined to be in a coverage area of said common base station.

7. Apparatus comprising:
a controller for controlling sending and/or receiving of information directly to and/or from a group of relay nodes by transmitter means and/or receiver means, wherein said controller is configured such that information for one relay node of the group is at least one of sent to and received from at least one other relay node of the group, each node of said group having a direct connection with a common base station.

8. Apparatus as claimed in claim 7, wherein said controller is configured to cause at least one of the following to be sent to at least one relay node of the group: configuration information; information for controlling the operation of one or more relay nodes; information for controlling an interface between a plurality of relay nodes; information for controlling channel allocation; information for controlling resource allocation of an interface portioning of said interface.

9. Apparatus as claimed in claim 7, wherein each relay node has a group identity, said group identity being the same for each relay node in the group, said information comprising said group identity.

10. Apparatus as claimed in claim 7, wherein each relay node has an identity, each relay node in said group having a different identity, said information comprising said respective relay node identity.

11. Apparatus as claimed in any of claim 7, comprising multiplexer means for multiplexing data for a plurality of different relay nodes of said group.

12. Apparatus as claimed in claim 7 comprising de-multiplexing means for de-multiplexing received data associated with a plurality of relay nodes.

13. An apparatus according to claim 7 wherein the controller is configured to define the group of relay nodes.

14. An apparatus according to claim 13 wherein the controller is configured to assign mobility parameters for the defined group of relay nodes.

15. An apparatus according to claim 14 wherein the controller is configured to distribute the mobility parameters to the relay nodes and/or other base stations of the defined group of relay nodes.

16. An apparatus according to claim 15 wherein the controller is configured to update a part or all of the mobility parameters of the relay nodes for distribution to the defined group of relay nodes.

17. A node comprising apparatus as claimed in claim 2.

18. A node as claimed in claim 17, wherein said node comprises a base station.

19. A relay node in a group of nodes comprising:
transmitter means and/or receiver means for sending and/or receiving information directly to and/or from a base station and at least one other relay node of the group of nodes, wherein information associated with another relay node of the group is at least one of sent to and received from said another relay node, said another relay node having a direct connection with said base station.

20. A relay node as claimed in claim 19, wherein said information comprises information from said another relay node and said transmitter means is configured to transmit said information from said another relay node to said base station.

21. A relay node as claimed in claim 19, wherein said information comprises information from said base station and said transmitter means is configured to transmit said information from said base station to said another relay node.

22. A relay node as claimed in claim 19, wherein said transmitter means comprises a wireless transmitter.

23. A relay node as claimed in claim 19 wherein said transmitter means is configured to transmit to said another relay node using a different band to the band used by said transmitter means to transmit to said base station.

24. A relay node as claimed in claim 19, wherein said transmitter means is configured to transmit to said another relay via a wired connection.

25. A relay node as claimed in claim 19, wherein a connection from the relay node to said another relay node is an enhanced X2 connection.

26. A relay node as claimed in claim 19, wherein said transmitter means is configured to send one or more of the following information to said base station: capacity information; capability information; status information relating to one more interfaces between said relay node and one or more other relay nodes of said group.

27. A relay node as claimed in claim 26, wherein said information to be sent to said base station is sent on initial activation or reactivation of said relay node.

28. A relay node as claimed in claim 26, wherein said information to be sent to said base station is sent in a re-configuration request or status indication of said relay node.

29. A relay node as claimed in claim 26, wherein said information to be sent to said base station is sent when said relay node changes cell.

30. A relay node as claimed in claim 26, wherein said information to be sent to said base station is sent periodically.

31. A relay node as claimed in claim 19, comprising multiplexer means for multiplexing data of said relay node with data of at least one other relay node of said group, said transmitter means being configured to transmit said multiplexed data to said base station.

32. A relay node as claimed in claim 19, comprising de-multiplexer means for de-multiplexing data received from said base station, said transmitter means being configured to transmit at least some of said demultiplexed data to at least one other relay node of said group.

33. A relay node according to claim 19 processing means for processing received information, the information comprising mobility parameters for a defined group of relay nodes.

34. A relay node according to claim 33 wherein the processing means distributes the mobility parameters to any of the at least one other relay node and the base station.

35. A relay node according to claim 33 wherein the processing means updates the mobility parameters for distribution to any of the at least one other relay node and the base station.

36. A relay node according to claim 35 wherein the information is updated in response to changes to the mobility parameters.

37. A relay node according to claim 33 wherein the mobility parameters comprise an active mobile context for the said defined group of relay nodes.

38. A relay node according to claim 37 wherein the active mobile context comprises one or more of the following: identity information of the defined group of relay nodes, identity of one or more relay nodes, physical arrangement information relating to one or more of the relay nodes, common configuration information for the defined group of relay nodes, status information of one or more of the relay nodes and capability information of one or more of the relay nodes.

39. A relay node according to claim 38 wherein the identity information of the defined group of relay nodes comprises a unique identity for the defined group of relay nodes.

40. A relay node according to claim 33 wherein the mobility information comprises handover information relating to the relay node and/or the at least one other relay node.

41. A relay node according to claim 40 wherein processing means determines timing of handover of the relay node from the handing timing information.

42. A relay node according claim 41 wherein the timing of hand over is determined from the physical dimensions of the defined group of relay nodes and the traveling speed of the defined group of relay nodes.

43. A relay node according to claim 33 wherein the processing means determines when handover of the relay node and/or the at least one other relay node from the first base station to the second base station is necessary on the basis of radio measurements of a current serving and neighboring cell.

44. A method comprising:
determining if a relay node is to be part of a group of relay nodes or to be treated as an individual relay node, wherein each relay node of said group of relay nodes is arranged to have a direct connection to a common base station; and
for those relay nodes in said group of nodes, at least one of
causing sending information to one relay node of said group, said information for another relay of said group and
causing receiving information from one relay node of the group, said information being received by said one relay node from another relay of the group.

45. A method as claimed in claim 44, wherein said determining is carried out when a relay node having a direct connection which said common base station is activated or reactivated.

46. A method as claimed in claim 44, wherein said determining is carried out periodically.

47. A method as claimed in claim 44 wherein said determining is carried out when the traffic load of the relay nodes and/or the base station has changed.

48. A method comprising:
determining for a group of relay nodes respective loading for each of said relay nodes, each of said relay nodes having a direction connection to a base station; and determining data scheduling for said group of relay nodes in dependence on said determined loading wherein said data scheduling is such that information for one relay node of the group is at least one of sent to and received from at least one other relay node of the group, said at least one other relay node having a direct connection with said node.

49. A method as claimed in claim 48, wherein said determining of respective loading comprises determining loading in a backhaul link.

50. A method as claimed in claim 49, wherein said backhaul link is wireless.

51. A method as claimed in claim 48, comprising sending information relating to said determined data scheduling to each relay of said group of relay nodes.

52. A method as claimed in claim 48, comprising sending information relating to said determined data scheduling to at least one relay of said group of relay nodes for forwarding to at least one other relay of said group of relay nodes.

53. A method as claimed in claim 48, wherein said determining the respective loading comprises determining loading between a relay node and user equipment and loading between said relay node and a base station.

54. A method as claimed in claim 53, comprising determining a ratio between said loading between said relay node and user equipment and loading between said relay node and the base station.

55. A method as claimed in claim 53, wherein said determining said data scheduling shares resources between links between the relay nodes and user equipment and one or more links between the relay nodes and the base station.

56. A computer program medium comprising a computer program configured to perform claim 44 when executed on a processor.

57. Apparatus comprising;
means for defining a group of relay nodes, each of said relay nodes of said group of relay nodes having a direct connection with a common base station; and
means for determining information scheduling for said group of relay nodes, wherein information for one relay node of the group is at least one of sent to and received from at least one other relay node of the group, said at least one other relay node having a direct connection with said node.

58. Apparatus comprising:
at least one processor and at least one memory including program code, the at least one memory and the program code configured to, with the at least one processor cause the apparatus at least to control sending and/or receiving of information directly to and/or from a group of relay nodes by a transmitter and/or receiver, such that information for one relay node of the group is at least one of sent to and received from at least one other relay node of the group, each node of said group having a direct connection with a common base station.

59. A relay node in a group of nodes comprising:
A transmitter and/or receiver configured to send and/or receive information directly to and/or from a base station and at least one other relay node of the group of nodes, wherein information associated with another relay node of the group is at least one of sent to and received from said an-other relay node, said another relay node having a direct connection with said base station.

60. Apparatus comprising:
at least one processor and at least one memory including program code, the at least one memory and the program code configured to, with the at least one processor cause the apparatus at least to perform
determining if a relay node is to be part of a group of relay nodes or to be treated as an individual relay node, wherein each relay node of said group of relay nodes is arranged to have a direct connection to a common base station; and
for those relay nodes in said group of nodes, at least one of
causing sending information to one relay node of said group, said information for another relay of said group and
causing at least one processor and at least one memory including program code, the at least one memory and the program code configured to, with the at least one processor cause the apparatus at least to perform receiving information from one relay node of the group, said information being received by said one relay node from another relay of the group.
